(19) United States
(12) Patent Application Publication
(10) Pub. No.: US 2005/0256785 A1
(43) Pub. Date: Nov. 17, 2005

(54) Animated virtual catalog with dynamic creation and update

(76) Inventors: Andrew J. Entwistle, Katonah, NY (US); Christopher J. Keenan, London (GB)

Correspondence Address: RICHARD E. NAWRACAJ, SUITE 1800, 123 N. WACKER DRIVE, CHICAGO, IL, 60606, US

(21) Appl. No.: 10/844,277

(22) Filed: May 12, 2004

(51) Int. Cl. G06F 17/60

(52) U.S. Cl. 705/27

(57) ABSTRACT

A system that displays images and other data of products in the form of an electronic catalog and displayed on a monitor or other viewing device. The system is designed to receive input from a user thereof and is animated to simulate the page turns of a conventional physical catalog. The system also provides for the automatic creation and update of its content through the use of a database containing product data, and maintains the ability to correlate products contained in the catalog for purposes of displaying related products, as well as products associated with the preferences or viewing and browsing history of the user.

### PRIORITY FILING DATE

This application claims the priority filing date of May 12, 2003 pursuant to the provisional patent filed on said date and entitled “Animated Virtual Catalog with Dynamic Creation and Update”.

### BACKGROUND OF THE INVENTION

1. Field of the Invention

The present invention relates generally to the field of software and, more particularly, to software that creates and updates animated virtual catalogs.

2. Description of the Background Art

Recent developments in computers, software and networking have enabled the development of electronic interactive media that allow a user to access information and, in some instances, to provide input in response to such information. Many instances such media devices take the form of electronic, or digitized, catalogs that display and receive information from a user. Such electronic catalogs do not, however, contain an automatic and dynamic method by which the information can be compiled, presented and updated. Therefore, there exists the need for a device by which the information presented in an electronic catalog or other display is automatically compiled, presented and updated from a database of information.

### SUMMARY OF THE INVENTION

The invention provides an automated method of assembling product images and data into an electronic virtual catalog that interfaces with a user through a computer monitor, interactive television interface, web browser, personal digital assistant and such other electronic devices that are able to transmit and display information to, and to receive input from, a user of such device. The product images and data may be in JPEG, TIFF, ASCII, text and such other formats that enable the storage and retrieval of information of such device. The invention also enables the automatic update of product information through the use of a dynamic link to a database or other depository containing the product images and data.

### BRIEF DESCRIPTION OF THE DRAWINGS

FIG. 1 is an illustration of the layout of the preferred embodiment of the animated virtual catalog.

FIG. 2 is an illustration of the index capabilities of the animated virtual catalog.

FIG. 3 is an illustration of page curl capabilities of the animated virtual catalog.

FIG. 4 is an illustration of the page title and page number capabilities of the animated virtual catalog.

FIG. 5 is an illustration of the search capabilities of the animated virtual catalog.

### DESCRIPTION OF THE PREFERRED EMBODIMENT

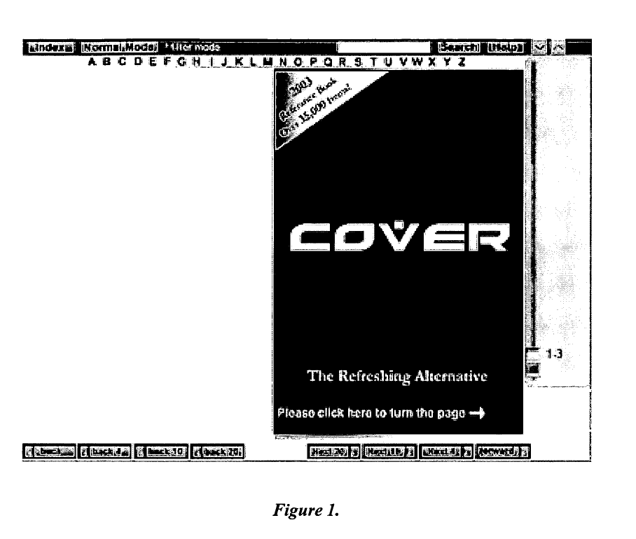

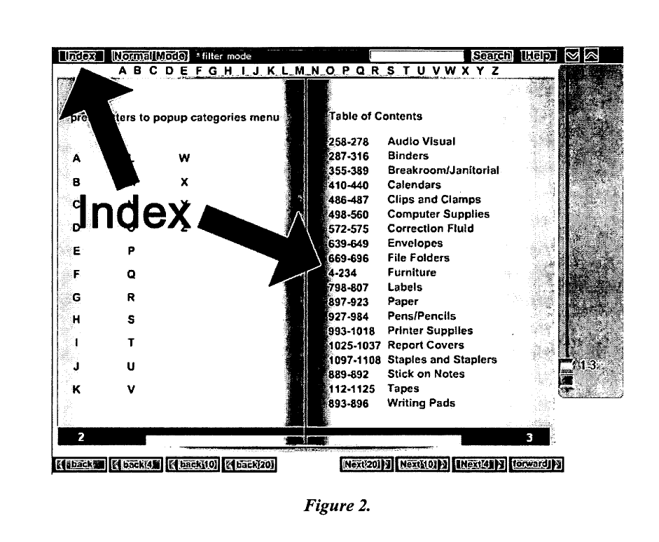

The animated, virtual catalog (hereinafter referred to as the “Virtual Catalog”) is an apparatus that displays, on a computer monitor or other electronic device able to transmit information to and receive input from a user, visual images of catalog pages, each of which contain images, descriptions, prices and other content and information of items contained thereon. The Virtual Catalog mimics a conventional, printed catalog in all relevant respects, including by way of example and not limitation: an image of front and back catalog cover; a table of contents and catalog index; and numbers for each page of the catalog that correspond to the appropriate references in the table of contents and index. See FIGS. 1 and 2.

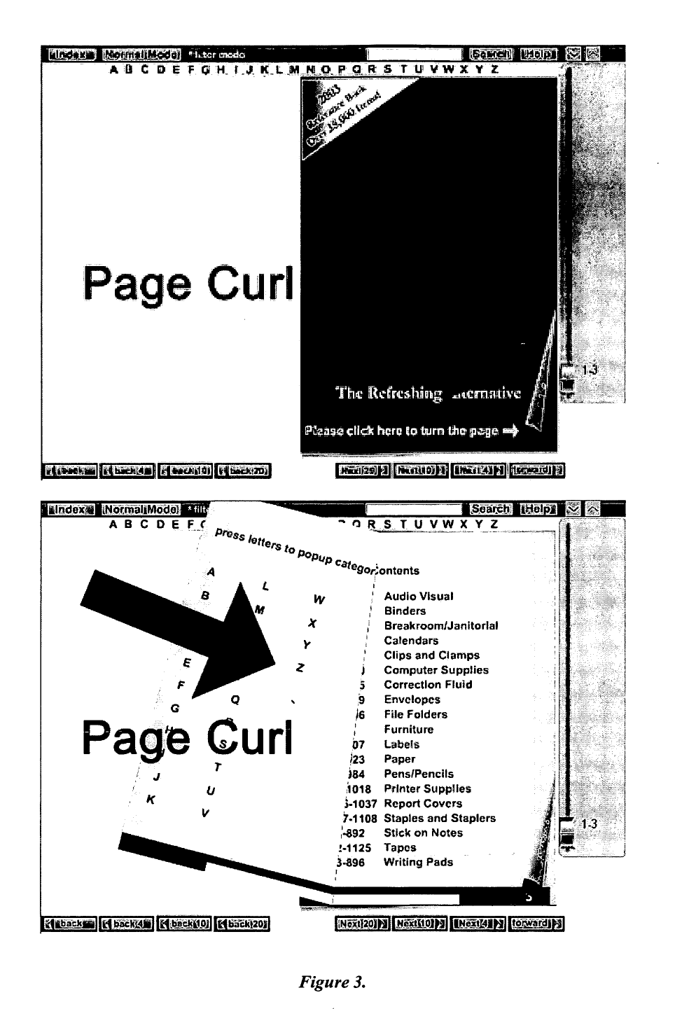

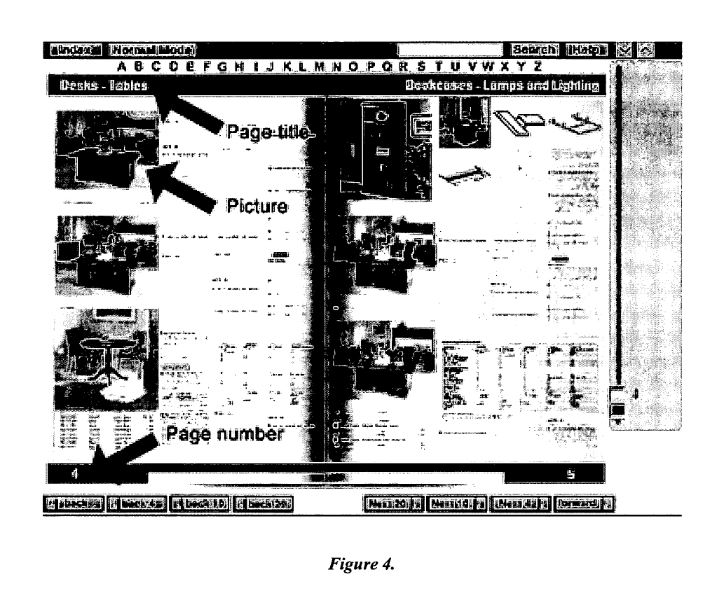

In the preferred embodiment, the Virtual Catalog also contains an animated page curl, which is created by a series of images played consecutively and which simulates the visual image of a page turn of a conventional, printed catalog. See FIG. 3. Further, in the preferred embodiment, each page of the Virtual Catalog contains a page title, describing the items contained on such page, as well as the images, descriptions, prices and other content and information of such items. See FIG. 4.

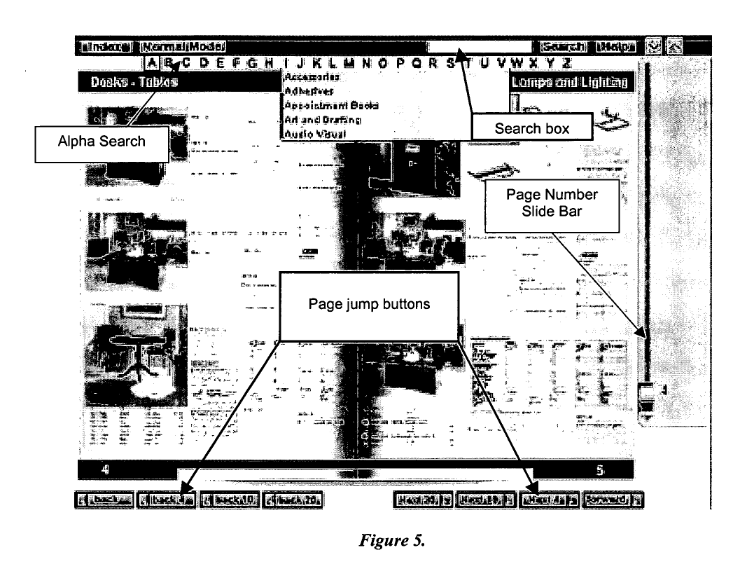

In the preferred embodiment, the Virtual Catalog also contains functionality whereby a user may search for a specific item contained anywhere within the catalog by way of inputting text describing such item and depressing a graphical search button. After depressing the graphical search button with the text query, the Virtual Catalog will direct the user to the catalog pages and the items contained thereon that maintain a description (or other identifier) bearing the text subject of the query. Alternatively, the items in the Virtual Catalog may be reviewed in alphabetical order by selecting the starting letter of the desired item description. See FIG. 5.

The preferred embodiment of the Virtual Catalog also provides for multiple browsing formats. Specifically, a user may browse on a page-by-page method by depressing the “next” or “back” buttons, which will display the next or previous page of the catalog, respectively. See FIG. 5. The Virtual Catalog also allows a user to browse the catalog by going forward or backward in increments of more than one page (see FIG. 5, in which the Virtual Catalog is programmed to browse forward or backward in increments of four, ten or twenty pages). Further, the Virtual Catalog allows a user to go to a specific page of the catalog by moving the page slide bar to the desired page number of the catalog. See FIG. 5.

The preferred embodiment of the Virtual Catalog also employs hyperlink capabilities that allow a user to navigate through the catalog to review particular items as well as general categories of items. In particular, the table of contents contains hyperlinks corresponding to each listing therein, which hyperlinks transport the user to the specific page reference upon activating such hyperlink (customarily though the depression of a mouse button or such other peripheral device). Similarly, the index contains hyperlinks associated with each reference listed therein, and by activating such hyperlink, a user will be transported to the page on which the corresponding indexed item is presented.

In the preferred embodiment, the Virtual Catalog also visually links the pictures of the items listed on each page to their corresponding description and other textual information. More specifically, the Virtual Catalog establishes a relationship between the picture of an item and its corresponding textual information so that when a mouse cursor (or similar peripheral device) is placed over the picture of the item, a bold border will appear around the textual information corresponding to such item. Conversely, if a mouse cursor (or similar peripheral device) is placed over textual information of an item, a bold border will appear around the picture corresponding to such item. The foregoing functionality is designed so that a user can quickly and easily identify both the picture (or other visual image) of a product and its corresponding description (or other textual information).

The preferred embodiment of the Virtual Catalog also provides an alternative method to providing the description or other textual information of an item. Specifically, instead of placing static text on each page of the Virtual Catalog, a semi-translucent text “pop up” box may be employed so that when a user places a mouse cursor (or such other peripheral device) over the image boundaries of an item, the description and such other textual information is displayed for such item.

In the preferred embodiment, the Virtual Catalog contains software programs and routines that enable the pages therein (including the table of contents and the index) to be created automatically through a dynamic link to a database or other depository containing the content for the catalog. This dynamic link apparatus and process between the software programs and routines, on the one hand, and the database or other depository containing content for the items for the catalog, on the other hand, also enables automatic updating of all of the items in the catalog. Therefore, the method and apparatus of the software program and routines linked to the database or other depository of content enables the creation and real-time, constant updating of the Virtual Catalog automatically and without any manual effort or other input on behalf of the user. The method by which the creation and updating of the Virtual Catalog through the dynamic link between the software code and routines and the database or other depository containing the desired content is explained below.

When initially run, the software and routines of the Virtual Catalog first establish a page background for the catalog. The background is the template that establishes the boundaries within which the content of the catalog pages will be displayed, which boundaries may be of varying designs and themes. During this first step, the software and routines also establish the buttons and other interfaces of the Virtual Catalog, including but not limited to the page browse buttons as well as the page slider.

The next step of the process concerns the loading of the data for the items contained in the Virtual Catalog, which data may be comprised of both visual and textual information and content. During this stage, a “loading data” message is displayed on the catalog background so that the user is informed that such process is occurring. Once the data load is complete, the “loading data” message is no longer displayed so that the user is informed that such process is finished.

During the loading of the data, the first sets of information extracted from the database or other depository of information are the page titles and numbers for the items. Such information is not part of a “pre-designed” catalog page image and, as such, can be altered or changed without altering a graphic or graphically preset page. In other words, a field box for the page number is placed at a particular coordinate of the catalog layout, which field box can display any alphanumeric quantity to which it is assigned during the data loading phase. Therefore, if a “2” is designated to be placed in such field instead of a “3”, a number “2” will be automatically placed on such page seamlessly and without the need for resetting or otherwise altering the graphically preset catalog layout. A similar field box is designated for the title at a particular location on the catalog layout, with such filed box able to display the alphanumeric text assigned to it during the data loading process. The page number and page title information held within a database or other data field is summoned through a query document (such as PHP, ASP or TXT).

The next event in the data loading process is to load and present the data and other information that relate to each particular catalog page. For this step, the Virtual Catalog software will search through the database or other depository of content to gather those items to which the particular page at issue is assigned (i.e., when loading data for page 11, the Virtual Catalog software will search and gather all items contained in the database to which the page number of 11 is assigned).

In the preferred embodiment, the data series for each item will contain a preference value for the size of the image to be displayed for such item. For example, a methodology may be established whereby the value of 100 indicates that such image should have the maximum possible area assigned to it on the page of the Virtual Catalog and, conversely, a value of 1 indicates that such image should have the minimum possible area assigned to it on the page of the Virtual Catalog. Further, in the preferred embodiment, before the data load, a user can specify the maximum and minimum area that an image for an item may occupy on each page. During the data load process and subsequent creation of the pages, the Virtual Catalog program dynamically and optimally arranges the items to be displayed on each page by: (i) computing the total number of pixels available for the page content by multiplying the height of the page, in pixels, by the width of the page, again in pixels; (ii) calculating the sum of the preference values for all of the items to be contained on the particular page; (iii) computing the pixel area per preference value; and (iv) using such quotient to compute the total pixel area for each item to displayed by multiplying such quotient by the preference value of each item to be displayed on a particular page. The images, which in the preferred embodiment would be in JPEG or similar file format, would be adjusted in size to their calculated pixel area as they are loaded by the Virtual Catalog software and, subsequently, placed on the appropriate catalog page in their optimum relative size.

The Virtual Catalog can also implement item correlation, which is essentially a numerical value that quantifies the positive or negative correlation between items contained in the database. The correlation data could be in the form of a multiple layer matrix (i.e., a two-by-two or three-by-three matrix) and would be used in conjunction with a specified scale (i.e., a value of “−1” would represent complete negative correlation while a “+1” would represent complete positive correlation). The correlation values would be implemented in the data series for each item and could be used in determining the layout of items on a particular page (i.e., items with positive correlations would be placed near one another, while items with negative correlations would be placed away from one another). The correlation value of the items may be initially determined arbitrarily by the database assembler, and may be static or fluid. A static correlation would be immutable and not changed through empirical calculations based on use of the catalog. A fluid correlation would be initially set at a particular value, but then altered based upon certain empirical calculations concerning the use of the Virtual Catalog (i.e., if a user of the Virtual Catalog frequently views items comprising erasers immediately after viewing items comprising pencils, then the correlation between these two items would be increased toward the “+1” value).

Upon a request to view different page, the virtual catalog performs the foregoing routine for such page designation, specifically, the: (i) searching of the item database for all of the items to be placed on the page; (ii) gathering of information specific to each item, such as but not limited to preference values and item correlations; (iii) compilation of all such information for the particular page; (iv) calculation of the most optimal arrangement of the items on such page; and (iv) placement of the items on the page

1. An animated virtual catalog comprising:
a database containing product images and other data;
a means for automatically assembling said product images and other data and displaying said assembly in visual images of catalog pages;
a means for displaying said visual images of catalog pages; and
a means for receiving input from the viewer of said visual images of catalog pages.

2. The animated virtual catalog of claim 1, further comprising a means for animating a page turn in said animated virtual catalog.

3. The animated virtual catalog of claim 1, further comprising a means for searching for a specific item in said animated virtual catalog.

4. The animated virtual catalog of claim 1, further comprising a means for browsing said animated virtual catalog on a page-by-page basis.

5. The animated virtual catalog of claim 1, further comprising a means for browsing said animated virtual catalog by displaying a page number inputted by a user thereof.

6. The animated virtual catalog of claim 1, wherein said animated virtual catalog contains hyperlinks enabling the display of specific items in said animated virtual catalog.

7. The animated virtual catalog of claim 1, further comprising a means for the pages of said animated virtual catalog to be automatically generated from a database containing information of products to be displayed in said animated virtual catalog.

8. The animated virtual catalog of claim 1, further comprising a means for correlating the products contained in said animated virtual catalog based upon numerical information associated with said products.

9. A method of creating an animated virtual catalog comprising the steps of:
accessing a database containing product images and other data;
automatically assembling said product images and other data and displaying said assembly in visual images of catalog pages displaying said visual images of catalog pages; and
receiving input from the viewer of said visual images of catalog pages.

10. The method of claim 9, further comprising the step of animating a page turn in said animated virtual catalog.

11. The method of claim 9, further comprising the step of searching for a specific item in said animated virtual catalog.

12. The method of claim 9, further comprising the step of browsing said animated virtual catalog on a page-by-page basis.

13. The method of claim 9, further comprising the step of browsing said animated virtual catalog by displaying a page number inputted by a user thereof.

14. The method of claim 9, further comprising the step of employing hyperlinks that enable the display of specific items in said animated virtual catalog.

15. The method of claim 9, further comprising the step of automatically generating the pages of said animated virtual catalog from a database containing information of products to be displayed in said animated virtual catalog.

16. The method of claim 9, further comprising the step of correlating the products contained in said animated virtual catalog based upon numerical information associated with said products.
